(19) United States
(12) Patent Application Publication
(10) Pub. No.: US 2023/0180768 A1
(43) Pub. Date: Jun. 15, 2023

(54) METHOD AND APPARATUS FOR CONTROLLING DARKLING BEETLES

(71) Applicant: Mary Ann Larose, East Hartford, CT (US)

(72) Inventor: Robert A. Larose, East Hartford, CT (US)

(21) Appl. No.: 18/081,630

(22) Filed: Dec. 14, 2022

Related U.S. Application Data
(60) Provisional application No. 63/289,950, filed on Dec. 15, 2021.

(51) Int. Cl. A01N 63/30

(52) U.S. Cl. CPC A01N 63/30; A01M 1/2011

(57) ABSTRACT

Darkling beetles are controlled by providing an effective amount of a fluid composition including an entomopathogenic fungus, to an infested location, using a composition delivery system to periodically apply a determined amount of spores to a specific target location.

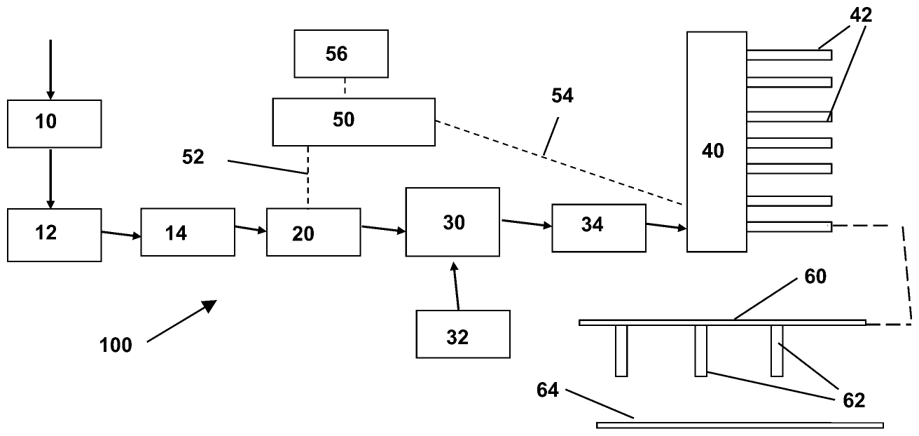

### CROSS REFERENCE TO RELATED APPLICATION

This application claims the priority of pending U.S. Provisional Patent Application 63/289,950, filed Dec. 15, 2021, which is incorporated herein by reference.

### BACKGROUND OF THE INVENTION

### 1. Field of the Invention

The present invention relates to a method and apparatus for the control of darkling beetles in animal enclosures.

### 2. Brief Description of the Prior Art

Darkling beetles are a common insect pest infesting animal enclosures such as poultry houses. The beetles can cause structural damage to the enclosure itself by burrowing into wood structures and insulation. In addition, the beetles can serve as vectors for transmitting infectious agents such as E. coli, Salmonella, Newcastle disease virus, poultry tapeworms, infectious bursal disease virus, astrovirus, coccidiosis protozoa, and the like. Further, the beetles can disturb birds causing excessive movement and reducing feeding and flock growth rate. Beetles may attack birds causing lesions, and predisposing birds to disease. In addition, the beetles may consume poultry feed reducing the amounts available for flock growth.

Beetle control measures include providing a leak-free bird watering system, as beetles require water for growth, avoiding poultry feed spills, maintaining a dry litter bed in the poultry house and application of insecticides. Poultry houses can be cleaned and disinfected between flocks.

Insecticides which can be employed include on-animal products, such as pyrethrins and spinosyns A and D, which can be used with live birds. Other insecticides having a residual effect, such as boric acid, can be applied to empty poultry houses in between flocks. An integrated pest management system can be beneficial.

Conventional control of darkling beetle infestations is typically done by use of a variety of toxic chemical insecticides. These are applied to the floor of the poultry house and sometimes to the structure of the house while the poultry are not present. However, these toxic agents leave a residual on the litter on the floor and provide only a two-week control of the population of beetles, which quickly rebounds and recovers during the typical grow-out period (about 12 weeks) to levels as high as or higher than they were before chemical treatment. Because of the toxicity of these insecticides, they can only be applied when birds are not present.

Beauveria bassiana is an entomopathogenic fungus, known to be effective as a mycoinsecticide against a variety of insect species.

### SUMMARY OF THE INVENTION

The present invention provides a process for controlling darkling beetles in a location. The process comprises providing a fluid composition including an entomopathogenic fungus, providing a composition delivery system for the composition, the composition delivery system including a metering pump, a plurality of emitters for delivering the composition to the location, tubing connecting the metering pump to the emitters; and delivering the fluid composition to the location through the composition delivery system.

Preferably, the process further includes providing a timing device to control the time at which the composition is delivered to the location and controlling the time at which the composition is delivered to the location. Preferably, the location comprises at least a portion of an animal enclosure.

In a presently preferred embodiment, the enclosure is a poultry house having a water delivery system, and at least a portion of the composition delivery system is provided adjacent to the water delivery system. In a presently preferred embodiment, the composition is delivered to a location infested with darkling beetles, the composition being provided in a sufficient quantity to control the darkling beetles. Preferably, the entomopathogenic fungus is selected from strains of Beauveria bassiana. Preferably, the Beauveria bassiana fungus is selected from the strains HF23, GHA, NFH2O and L90. In one embodiment, the concentration of the entomopathogenic fungus is from 10⁶ to 10⁸ spores per ml. Preferably, the composition is an aqueous composition prepared from an emulsified concentrate including the fungus as spores. Preferably, the enclosure is a poultry house having a centerline, and the location is along the centerline. Preferably, the composition is applied intermittently over a grow-out period of a poultry flock. In one embodiment, the delivery system delivers a dose of from about 10⁶ spores per cm² of the location to about 10¹⁰ spores per cm² of the location at least once per week. Preferably, the composition further includes an attractant for the darkling beetles. Preferably, the attractant comprises a nutrient.

In another aspect, the present invention provides apparatus for the control of darkling beetles at a location. The apparatus includes a delivery system for delivering a fluid composition including spores of an entomopathogenic fungus. The composition delivery system includes a metering device or metering pump, a plurality of emitters for delivering the composition to the location, tubing connecting the metering device to the emitters, and a timing device to control the time at which the composition is delivered to the location.

Preferably, the apparatus further includes a device for mixing the spores with a carrier fluid or diluent.

### BRIEF DESCRIPTION OF THE DRAWING

The FIGURE is a schematic illustration of an apparatus according to the present invention.

### DETAILED DESCRIPTION

The present invention provides a novel device and method to control darkling beetles in a poultry house. The method is based on a liquid formulation of a biological fungus product using spores such as those of Beauveria bassiana strain HF23 (available from Jabb of the Carolinas, Pine Level, N.C.). Darkling beetles are impactful within a poultry house. The present invention provides a better, non-chemical solution to the problem than conventional chemical methods.

The present invention provides control of the darkling beetle population affecting both the adult beetle and the larvae with a biological agent such as Beauveria bassiana. The Beauveria bassiana is a beneficial fungus that is commercialized in a dry, dormant spore stage. This dry form of Beauveria bassiana can be applied either as a dry powder or a liquid emulsified concentrate. Beauveria bassiana is also known as a seed inoculant which establishes a symbiotic relationship with plants to mitigate pathogens.

In one aspect of the method of the present invention Beauveria bassiana is formulated into a liquid concentrate that includes compounds that will act as an attractant for the beetles, such as starches. In one presently preferred aspect, the attractant includes at least two such attractants.

In one aspect of the invention, the entomopathogenic fungus can be employed in the form of an aqueous composition including inoculums selected from aerial conidia, in vitro blastospores and submerged conidia.

In one aspect of the method of the present invention a fluid composition including the Beauveria bassiana is applied to poultry litter. In particular, the fluid composition is applied to a specific area or location within a poultry house, instead of treating the entire floor space of the house, which can be more than 20,000 square feet.

Preferably, in the process of the present invention a liquid Beauveria bassiana-containing composition is applied down the centerline of the house where the feed and drinking water lines are located. The darkling beetles are naturally drawn to the center of the house due to their need for food and water.

The present invention provides an effective solution to the challenge of getting a biological product to work within a poultry house. The beetles must encounter the Beauveria bassiana spores for the spores to become attached to the body of the beetle and germinate within the body of the darkling beetle. This process of infection causes the beetle to die.

Multiple low volume applications of the Beauveria bassiana are required during the entire 12 weeks (about three months) of grow-out to create enough infection within the house to get control of the beetle population.

However, multiple applications problematically require labor and time associated with spraying weekly or sometimes twice a week.

Good poultry practice dictates that good biosecurity is required to maintain the health of the flock. Thus, entry into the house during the time of grow-out is severely restricted to keep the birds calm and free from potential infection by outside intruders.

In one aspect, the present invention provides apparatus for the delivery of a fluid composition including an automatic delivery system.

In one aspect, the automated delivery system preferably utilizes a plastic hose that has a number of drip emitters installed on the plastic hose of ¼ inch diameter with emitters preferably placed every 18 inches along the length of the drip tubing. The tubing and emitters are strung adjacent to the existing water lines that are typically located down the centerline of the poultry house. The drip tube assembly terminates at one end of the house where it is connected so an injection system injects a predetermined amount of Beauveria bassiana formulation into the tubing by a chemical pump.

The chemical pump is preferably controlled by a timer to turn the pump on and off as required to allow for intermittent dosing of a Beauveria bassiana product through each emitter suspended down the centerline of the poultry house directly adjacent to the drinking lines.

This injection system allows for a predetermined amount of Beauveria bassiana to be dispensed directly on the poultry litter at various times throughout the day and week to allow for enough biological spores to come into contact with the darkling beetles during the course of time the chickens are in the house, allowing for a proper amount of infection of the beetles to reduce their population to a number at which they are no longer a detriment to the flock.

The system, while allowing for a consistent method of applying a consistent amount of biological agent to the litter, also reduces any labor associated with this operation and allowing the chickens or turkeys a reduction of stress and a dramatic improvement to the health and welfare of the poultry flock.

The delivery system provides a biologically effective dose of spores to the location at least once per week for twelve weeks. “Biologically effective” dose means a dose sufficient to control a darkling beetle infection.

A schematic diagram of an embodiment of the apparatus of the present invention is shown in the FIGURE.

A composition delivery system 100 includes an inlet 10 for dilution water, which passes through a check valve 12 to prevent backflow from the delivery system, and subsequently through a pressure control valve 14 adapted to maintain the pressure of the fluid composition being delivered within a desired operating range, and thence to a master valve 20 for controlling the flow of the dilution water through the delivery system 100. The dilution water then flows from the master valve 20 to a metering device 30, such as a mechanically driven mixing device (e.g. “Dosatron” water powered mixing pumps, Dosatron International LLC. Clearwater, Fla.; “Pulsapro”, Pulsafeeder, Punta Gorda, Fla.) or an electrically powered dosing device. A supply of fluid concentrate 32 including emulsified spores and at least one attractant for darkling beetles is also provided to the metering device 30, which injects the fluid concentrate into the dilution water.

The mixture then flows from the metering device 30 through a mixing chamber 34 and then to a zone manifold 40 for distributing the mixture to one or more lines 42 extending to a poultry house. Lines 60 are suspended above the surface of the poultry house and are preferably strung adjacent the food and water delivery systems conventionally placed along the centerline of the poultry house.

The poultry house lines are fitted with a plurality of emitters 62 for spraying or dripping the fluid composition onto target area locations 64 under the emitters on the floor of the poultry house which is typically covered with litter. For example, 85 emitters or drippers can be fitted on a 200-foot line. The opening of the master valve 20 is controlled by a control device 50 through a control line 52. The control device 50 is also preferably provided with a monitor line 54 for monitoring the flow of the fluid mixture from the metering device 30 through a corresponding flow sensor (not shown). Alternatively, the metering device may be a conventional chemical feed pump for injecting the concentrated emulsified spore-containing composition into the dilution water.

The operation of the control device 50 is itself controlled by a timing device 56. In operation, dilution water is provided through the master valve 20 to the metering device 30, along with an emulsified concentrate of Beauveria bassiana spores and attractant, to provide a dilute mixture of the Beauveria bassiana spores and attractant which is subsequently distributed to emitters such as spray nozzles positioned along the centerline of the poultry house, where the falling mixture wets the litter covering the floor. The amount of Beauveria bassiana spores applied, the duration of the period of application, and the frequency of application are controlled by the timing device, and preferably selected to infect a darkling beetle population with the Beauveria bassiana spores in sufficient quantity to effectively control an infestation.

In one aspect of the process of the present invention, a fluid fungal composition including a Beauveria bassiana spore concentrate is diluted 1 part to 100 with process water and is delivered at a pressure of 15 psi to deliver about 10 ml of the undiluted composition per minute per emitter/dripper. The delivery system can then be activated for a minute twice a week in order to control an infestation of darkling beetles.

Various modifications can be made in the details of the various embodiments of the apparatus and method of the present invention, all within the scope and spirit of the invention as defined by the appended claims.

1. A process for controlling darkling beetles in a location, the process comprising:
a) providing a fluid composition including an entomopathogenic fungus,
b) providing a composition delivery system for the composition, the composition delivery system including a metering pump, a plurality of emitters for delivering the composition to the location, tubing connecting the metering pump to the emitters; and
c) delivering the fluid composition to the location through the composition delivery system.

2. The process according to claim 1 further comprising:
d) providing a timing device to control the time at which the composition is delivered to the location, and
e) controlling the time at which the composition is delivered to the location.

3. The process of claim 1 wherein the location comprises at least a portion of an animal enclosure.

4. The process according to claim 3 wherein the enclosure is a chicken house having a water delivery system, and at least a portion of the composition delivery system is provided adjacent to the water delivery system.

5. The process according to claim 2 wherein the composition is delivered to location infested with darkling beetles, the composition being provided in sufficient quantity to control the darkling beetles.

6. The process according to claim 1 wherein the entomopathogenic fungus is selected from the group consisting of Beauveria bassiana and Metarhizium anisopliae/brunneum.

7. The process according to claim 6 wherein the Beauveria bassiana fungus is selected from the strains HF23, GHA, NFH2O and L90.

8. The process according to claim 1 wherein the concentration of the entomopathogenic fungus is from 10⁶ to 10⁸ spores per ml.

9. The process according to claim 1 wherein the composition is an aqueous composition prepared from an emulsified concentrate including the fungus as spores.

10. The process according to claim 3 wherein the enclosure is a chicken house having a centerline, and the location is along the centerline.

11. The process according to claim 3 where the enclosure is a chicken house, and the concentration of the composition comprises from about 10⁶ to 10⁸ spores per ml.

12. The process according to claim 5 wherein the composition is applied intermittently over a grow out period of a chicken flock.

13. The process of claim 1 wherein the delivery system delivers a biologically effective dose of spores to the location at least once per week for twelve weeks.

14. The process of claim 1 wherein the composition further includes an attractant for the darkling beetles.

15. The process of claim 1 wherein the attractant comprises a nutrient.

16. Apparatus for the control of darkling beetles at a location, the apparatus comprising a delivery system for delivering a fluid composition including spores of an entomopathogenic fungus, the composition delivery system including a metering device, a plurality of emitters for delivering the composition to the location, tubing connecting the metering device to the emitters, and a timing device to control the time at which the composition is delivered to the location.

17. The apparatus according to claim 16 further comprising a device for mixing the spores with a carrier fluid.
